(19) United States
(12) Patent Application Publication
(10) Pub. No.: US 2011/0119089 A1
(43) Pub. Date: May 19, 2011

(54) System and Method for Personal Electronic Medical Records

(76) Inventor: Jeffrey A. Carlisle, Stratham, NH (US)

(21) Appl. No.: 12/950,282

(22) Filed: Nov. 19, 2010

Related U.S. Application Data
(60) Provisional application No. 61/262,700, filed on Nov. 19, 2009.

(51) Int. Cl. G06Q 50/00; G06Q 10/00

(52) U.S. Cl. 705/3

(57) ABSTRACT

An electronic medical record system and method enables a patient and the patient's caregivers to create, maintain, and use an electronic medical record over a secured communication network, such as the Internet.

### BACKGROUND

The present disclosure relates to an improved system and method for creating an electronic medical record, and specifically, to an electronic medical record system and method which incorporate components for completeness, accuracy, and accessibility into one system. The present inventor has identified several essential elements for an electronic medical record system (e.g., professional support, paper record extraction, electronic data exchange, subjective data collection, legible and secure format, elimination of duplicative data entry, audit by patient and caregivers, transfer to other databases, generation of a complete report, and integration with existing forms) which have been combined to provide the system and method discussed herein.

No matter what the cost or complexity, the state-of-the-art electronic medical records do not satisfy the requirements of an electronic medical record that can form the basis for improved healthcare process. Although it is commonly posited that electronic medical records will reduce costs and improve the quality of healthcare, there is no data which supports that supposition for the currently available electronic medical record systems. The presently available electronic medical record systems lack one or more essential elements, thereby creating significant deficits in one or more of the areas of completeness, accuracy, or accessibility. The absence of one or more elements that creates a deficit in completeness, accuracy, and/or accessibility creates substantial barriers to effective use of the currently available electronic medical record systems.

The present disclosure contemplates a new and improved system for creating and using an electronic medical record, which adds enough value to the electronic medical record to favorably alter the healthcare delivery process.

### SUMMARY

The present disclosure provides an improved system to create an electronic medical record using a series of inter-related technologies and methods which provide the basis for a service owned and controlled by the patient or the patient's custodian. Since a medical record, by itself, has no therapeutic value, it must be in a format that enables it to be effectively put to use in the healthcare system. The series of inter-related technologies and methods of the present disclosure guide patients through the creation, maintenance, and use of a personal electronic medical record that is more complete, accurate, and accessible than other methods. The electronic medical record of the present disclosure provides an optimal format to ensure it is effectively used in the healthcare field by using tools that provide lower costs and higher levels of security.

In one aspect, a professional support service may be provided to guide a patient through the creation, maintenance, and use of his or her electronic medical record. The professional support service is advantageous in that it can ensure that the patient's electronic medical record is more complete, accurate, and accessible than other medical records. This professional support service is combined with an electronic medical record process addressing the collection, storage, editing, analysis, and reporting of data for personal electronic medical records. The well-designed electronic medical record system of the present disclosure has the potential to reduce the cost of healthcare by providing patients and caregivers easy access to their medical records.

In one aspect, an electronic medical record system includes a processor for executing an electronic medical record program and a memory for electronically storing personal data and medical record data associated with a patient. A digital representation of one or more original source documents associated with the patient are also stored in the memory and are retrievable in human viewable form by an operator. The electronic medical record system further includes one or more input devices for entering and/or editing the personal data, the medical record data, or both.

In another aspect, a method for creating an electronic medical record includes collecting medical record data from a patient, a caregiver, or both, storing the medical record data in a database, and associating the medical record data with the patient. A digital representation of one or more source documents containing medical record data from the patient is stored in the database and associated with the patient.

In a more limited aspect, a medical record integration service is provided which is comprised of a relational database which stores historical and current medical record information including but not limited to family medical history, current medical problems, current medications, surgical history, previous prescriptions, diagnostic tests data and results, and other information elements that would be commonly found in a patient's medical record maintained by a primary care physician or specialist, wherein the database is accessible from the Internet using secure connections, e.g., security methods typically seen with online banking. The database allows retention of original source documents, images, or reports as digitally stored and retrievable elements. A medical record specialist may provide services to integrate, filter, abstract, and resolve conflicts on behalf of the patient; where the medical record specialist has administrative access to the patient's record via a network, such as the Internet. The medical record specialist may use tools to support medical record entry and codification such as optical character reading, guided data entry interrogation systems (e.g., menu-based interface, online or on screen questionnaire, interactive wizard or interviewing-type interface, etc.) voice recognition, and so forth. A software module may also be provided which provides an interviewing experience directly with a patient and extracts the results of the interview as subjective information incorporated into the patient's record may also be provided. For example, the present development may employ commercially available patient interview or medical history software, such as Instant Medical History™, which uses branching logic to ask patients questions about specific medical conditions, general health, or family history. A software module may be provided which converts the electronic record into an electronic form that is compatible with a caregiver's own electronic information system. A software module may also be provided to map database fields from the database of the present system to a form required for import by the system in use by the recipient. Such formats may be in accordance with promulgated medical records standards, such as ASTM CCR, (Continuity of Care Record) format or similar standard. A reporting module may be provided to software convert the electronic record into a printable form that is compatible with a caregiver's own paper-based information system and/or a human viewable form for display on a display system. The present system preferably also provides the ability to map database fields onto a printed template, e.g., based on forms currently in use by the recipient of the record, in other words, creating a printed report using the doctor's own format.

Still further benefits and advantages of the present development will become apparent to those skilled in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a system block diagram of the information flow for an exemplary electronic medical record system in accordance with this disclosure.

FIG. 2 is a system block diagram of the professional support services system of the exemplary electronic medical record system herein.

FIG. 3 is a system process flow diagram of the five medical record processes of the exemplary electronic medical record system herein.

FIG. 4 is a system block diagram of an exemplary embodiment of the electronic medical record system herein.

FIG. 5 is a system block diagram illustrating an exemplary web browser-based embodiment of the electronic medical record system in accordance with this disclosure.

### DETAILED DESCRIPTION OF THE PREFERRED EMBODIMENTS

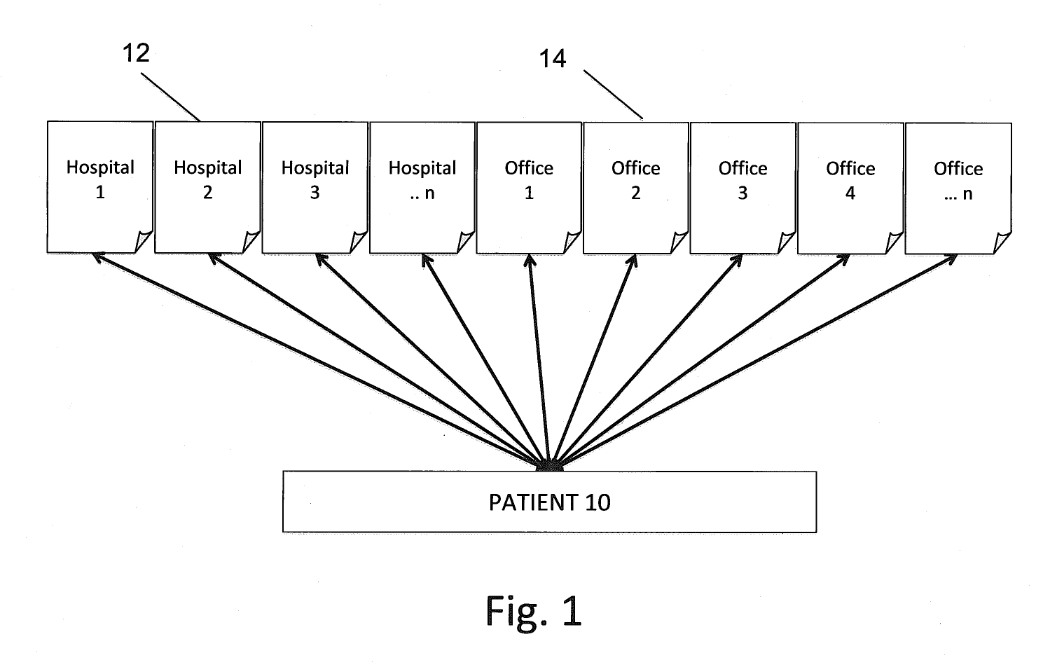

Referring to the drawings, wherein like reference numerals refer to like or analogous components throughout the several views, and with particular reference to FIG. 1, there appears a system block diagram illustrating the point of connection for all information in a preferred embodiment electronic medical records system of the present disclosure. At the center of the electronic medical record process is the patient 10, who is the locus for all medical record information from hospitals 12 and doctor's offices 14 which the patient 10 may visit, because the patient 10 is the common thread. The patient 10 begins the electronic medical record process by creating an electronic medical record account with the assistance of a professional support service system 200 via a computer on a network, such as the Internet. Once the patient 10 has created an electronic medical record, the patient's caregivers may access the electronic medical record through a computer network to review and make additions to the patient's medical record as necessary.

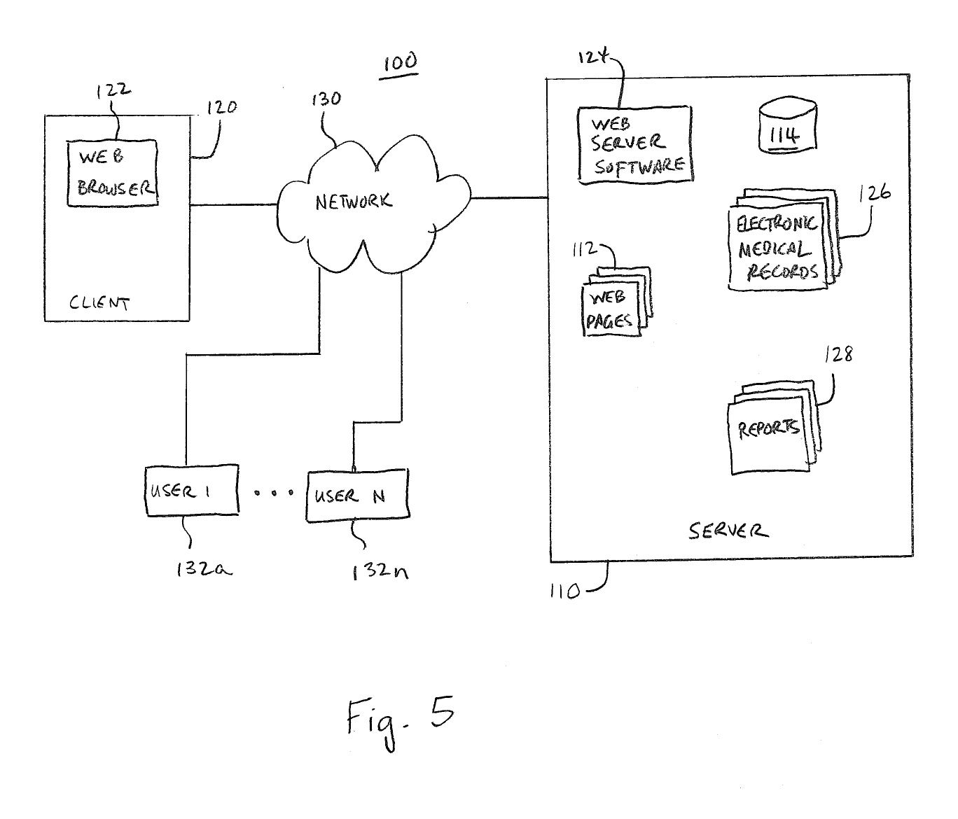

With reference now to FIG. 5, a block diagram depicting an exemplary networked information handling system 100 in accordance with a preferred, web browser-based embodiment of the present invention is shown. The information handling system 100 includes one or more network servers 110 interconnected with one or more remotely located client computer systems 120 configured to allow a user to use a web browser 122 over a network 130. The client computer system 120 and server computer system 110 may be, for example, a computer-based information handling system such as a personal computer. Although the present invention will be described primarily herein by way of reference to a personal computer equipped with a web browser, it will be recognized that the present invention may be implemented in any type of computer-based information handling system, including but not limited to general purpose or personal computers, workstations, hand-held computers, convergence systems, information appliances, Internet appliances, Internet televisions, Internet telephones, personal digital assistants (PDAs), personal information managers (PIMs), portable communication devices such as portable or mobile telephones, hand-help or mobile devices, PDAs, web browser (including wireless web browser) equipped devices, or the like, having a wired or wireless network connection or capability.

Where the electronic medical record system is accessible from the Internet, the network used by the patient or caregiver to access the electronic medical record system should be a secure encrypted connection over the Internet or other Wide Area Network. The live, real-time, secure, encrypted connection is preferably a 128-bit encrypted local area network (LAN) connection, but may also be a 256-bit encrypted remote connect, or any other secure encrypted network connection.

Likewise, although the present development will be described primarily herein by way of reference to an online application, such as an application designed to run primarily from a Internet browser as a set of hypertext markup language (HTML), or World Wide Web (Web) documents or pages, it will be recognized that the present development can also be embodied as a standalone application for execution on a computer information handling system of the user or operator, such as a stand alone computer or a computer accessed via a network of the user or operator. Thus, the present invention may be accessed directly from the Internet, an intranet or other network, or may be distributed to users by any computer distribution mechanism, including CD-ROM and DVD, and the like.

The network 130 interconnecting the server 110 and the remote client system 120 can include, for example, a local area network (LAN), metropolitan area network (MAN), wide area network (WAN), and the like, and interconnections thereof. The network connection 130 can be an Internet connection made using the World Wide Web, an intranet connection, or the like.

The server computer system 110 and the client computer system 120 interact by exchanging information via the communications link 130, which may include transmission over the Internet. In the depicted, web browser-based embodiment, the server 110 receives hypertext transfer protocol (HTTP) requests to access web pages 112 identified by uniform resource locators (URLs) and provides the requested web pages to the client computer system 120 for display using the browser 122, as is generally known in the art.

To create an electronic medical record account in the exemplary web based embodiment depicted in FIG. 5, the server system 110 operates web server software 124. An operator may access the server software 124 by operating the client computer system 120. The operator may be the patient, but is advantageously the patient in conjunction with a professional customer support services with personnel, such as a medical records professional trained in the operation of the program. Alternatively, a self-guided system is also contemplated, e.g., employing an interactive or menu-driven interface, online support materials, etc. The client computer system 120 operates the web browser software 122 that allows the user to download and display one or more HTML files, or web pages, 112 contained on the server computer system 110. It will be recognized that the present invention may be implemented in any of a host of programming languages may be run as client/server application, thin client application, or a stand-alone application.

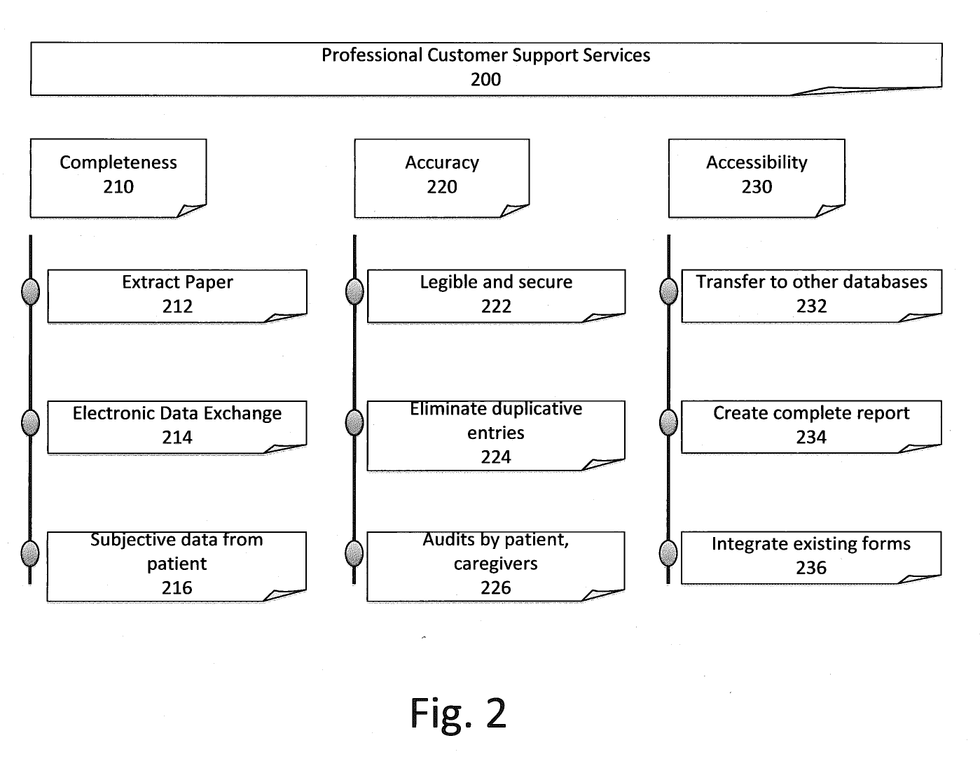

Referring now to FIG. 2, an exemplary data input process employing professional support services 200 is shown. In operation, patient 10 is guided through the creation, maintenance, and use of a personal medical record, e.g., by a medical record professional of the professional support service system 200. The medical record professional from the professional support service 200 provides services to the patient to integrate, filter, abstract, and resolve conflicts on behalf of the patient. The professional support services 200 have administrative access to the patient's records via a secured encrypted connection over the Internet. The use of professional support service 200 is preferred because the process of managing a medical record requires a significant level of training, specialized database tools, and compensation that are typically beyond the scope of a patient. Therefore, the use of professional support services 200 to assist the patient in the creation and management of his or her own medical record is preferred.

The professional support service system 200 comprises three steps or modules for the creation, maintenance, and use of the patient's 10 medical record, namely, a completeness module 210, an accuracy module 220, and an accessibility module 230. The completeness 210 module includes three elements, which are paper record extraction 212, electronic data exchange 214, and subjective data collection from the patient 216 to ensure the medical record is complete. The medical record professional may use optical character reading tools, guided data entry interrogation system tools, and voice recognition tools to support medical record entry and codification. The accuracy module 220 includes a legibility/security module 222, a redundancy module 224, and an audit module 226 for auditing the medical record data by the patient and/or caregivers, to ensure the medical record is free of errors. Finally, the accessibility module 230 includes three components, namely, a transfer module 232 enabling the transfer of the data to other databases, a report module 234, and a forms module 236 for integration with existing forms. In this manner, an electronic medical record is created that is available to and useable by all caregivers, e.g., users 132a-132n.

The paper record extraction component 212 is a service to extract a data set to be incorporated into a personal medical record 126. Various technologies and methods may be employed in paper record extraction 212 to collect medical information concerning a patient, including data from existing records in manually maintained paper records. Extraction of data from paper records is advantageous to the medical record process because the vast majority of medical information is presently in a paper form. Exemplary technologies and methods for paper record extraction include, for example, manual review, abstraction, and transcription by a subject matter expert, electronic image scanning and optical character recognition coupled with natural language processing, and others. When electronic image scanning is used for paper record extraction the database retains the original source documents, images, and reports that were originally scanned into the system as digitally stored, and retrievable elements.

The electronic data exchange module 214 provides the ability to upload or import a data set from an existing database into a personal medical record, thereby enabling caregivers to exchange information electronically. The electronic data exchange module 214 is particularly advantageous because vital information about the patient may already be in an electronic format and the electronic data exchange module 124 eliminates the need to manually re-enter this information, which would increase the cost of creating the electronic medical record. The data exchange module 214 includes application logic for accessing data, e.g., in the form of SQL queries or standardized database connections, and manage the data and its structure, e.g., in the form of a database 114. The data exchange module 214 enables the conversion of an electronic medical record into an alternate electronic form, such as a format that is compatible with a caregiver's electronic information system.

The data associated with each electronic medical record may be stored in a database preferably a relational database. Correspondence or associations between the electronic medical record data and alternative electronic medical record formats or medical forms, templates or the like may be accomplished via relations or tables in a relational database, although other methods are contemplated such as associations stored in a look up table or other data file or storage device. The relational database stores historical and current medical record information including but not limited to family medical history, current medical problems, current medications, prior prescriptions, surgical history, diagnostic test data, diagnostic test results, and other information elements which would be commonly found in a primary care physician or specialist's medical record for a given patient.

The subjective data collection module 216 may be an interactive sub-system to systematically, rigorously, and completely collect information directly from the patient and incorporate it into the personal electronic medical record. The subjective data collection module 216 may use, for example, a series of interactive prompts, software wizard interface, etc. This subjective information is important to a patient's medical record. The use of an interactive data collection interface enables the collection of data that could not be achieved using non-interactive forms.

Accuracy is ensured in the presently disclosed system because all electronically stored information is easily put into a legible and secure format 222 which provides a structure to all electronic data. The medical record, once established in an electronic form, is maintained securely in a legible and secure format 222 and is under the patients' control. Insuring legibility and security reduces the chance that the interpretation of information may be compromised by handwriting errors, lost data, or corrupted data.

The elimination of duplicative or redundant data entry 224 is advantageous for a single, patient-centered data repository and improves the accuracy of a patient's electronic medical record 126. For example, if each medical encounter starts with “tabula rasa,” then each question asked and answered provides another opportunity for error. These errors could be related to misinterpretation of the question, or transcription error, or the inability to correctly remember the correct answer at that point in time. On the other hand, if the questions have been asked once and continuously or periodically reviewed for accuracy and completeness, the data is much more likely to be complete and accurate.

The accuracy of an electronic medical record 126 is also monitored by periodic patient and caregiver audits 226. Patient and caregiver audits 226 allow the stakeholders that are closest to the data, including the patient, to have access to all of the information in the record to find errors of commission and omission. Audits reduce the likelihood of medical errors based on repetitive reliance on incorrect data or gaps contained in a medical record.

The data transfer module 232 provides the ability to transfer data in the medical record 126 to other databases allows the data from the patient's medical record to be faithfully and efficiently entered into other systems and structured databases, e.g., databases contained in the information handling systems of caregivers or institutions responsible for the patient's care. The data transfer module 232 may be database management software that responds to requests to access data in the database 114. The data transfer module may advantageously use recognized standards to codify and transfer medical information, such as HL-7, Snomed, etc.

The report module 234 allows the data from the patient's electronic medical record to be presented in a complete and useful report 128, which can be provided to caregivers.

The integration module 236 converts the electronic data from the patient's electronic medical record into the current workflow process of the caregiver and integrates the data into existing forms, even if the caregiver's workflow uses paper records. The ability to integrate with existing forms enables the electronic medical record to be put into a paper format that is used by various caregivers and mirrors the caregivers' current paper format. In this manner, an electronic medical record can be integrated into an existing form without disrupting the current workflow of the caregiver. Even an ideal electronic medical record is likely to be discarded if presented to a physician or caregiver in a “foreign” format.

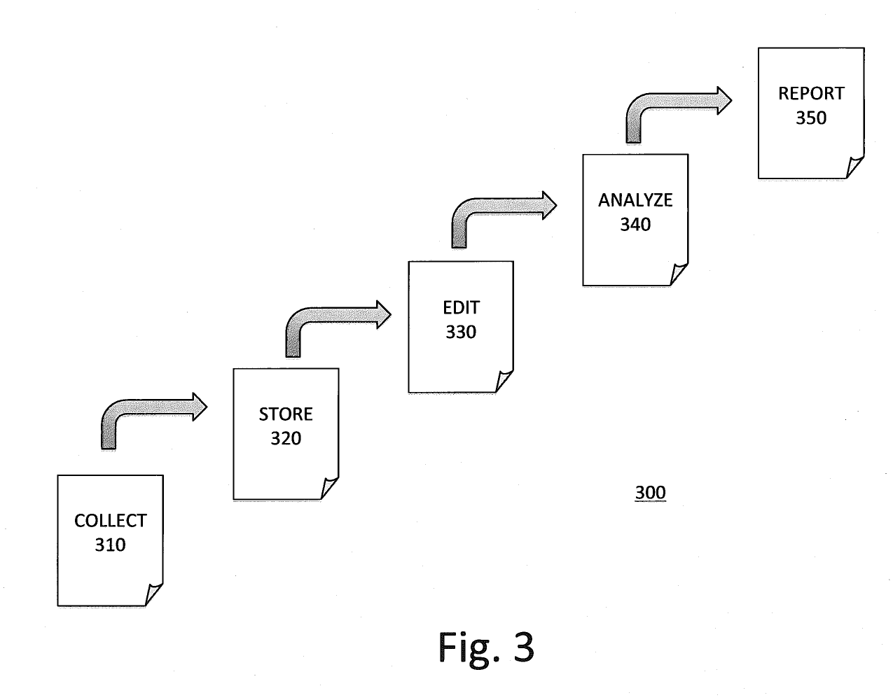

Referring now to FIG. 3, an exemplary five step electronic medical record process is shown. The illustrated medical record process includes a collect step 310, a store step 320, an edit step 330, an analyze step 340, and a report step 350. At step 310, necessary information for the creation of an electronic medical record is gathered. At step 320, the information gathered during step 310 is stored, e.g., in the database 114, for later retrieval and editing. Once data is stored, an electronic medical record 126 is created and a patient or the patient's caregivers can make necessary changes to the information during the edit step 330. Once the electronic medical record 126 has been edited, the record 126 is analyzed at step 340.

The analysis of a medical record may include receiving information or data associated with a patient and analyzing the data for any one or more of errors, gaps, redundancies, and so forth, and assessing the input data by comparing the data to previously entered or stored data associated with the patient. Additionally or alternatively, the analysis of a medical record may include the thoughtful review of its data in the total context of the patient's record. In preferred embodiments, the analysis may not be seen as a single event, but rather a periodic or continuous process by which data is challenged for its completeness and accuracy. For example, a review of all medications will often provoke questions about side effects. Family history questions will often be expanded upon after reflection. There are limitless combinations of errors of commission and omission that may be found in reviews of medical records.

After the electronic medical record has been analyzed, various reports 128 can be created, e.g., in a format suitable for human-viewable output or display, at step 350.

Although the process is shown in linear fashion for ease of exposition, it will be recognized that the interface may advantageously provide an opportunity during the process to return to any step whenever it is desired or necessary to update, edit, or analyze the medical information.

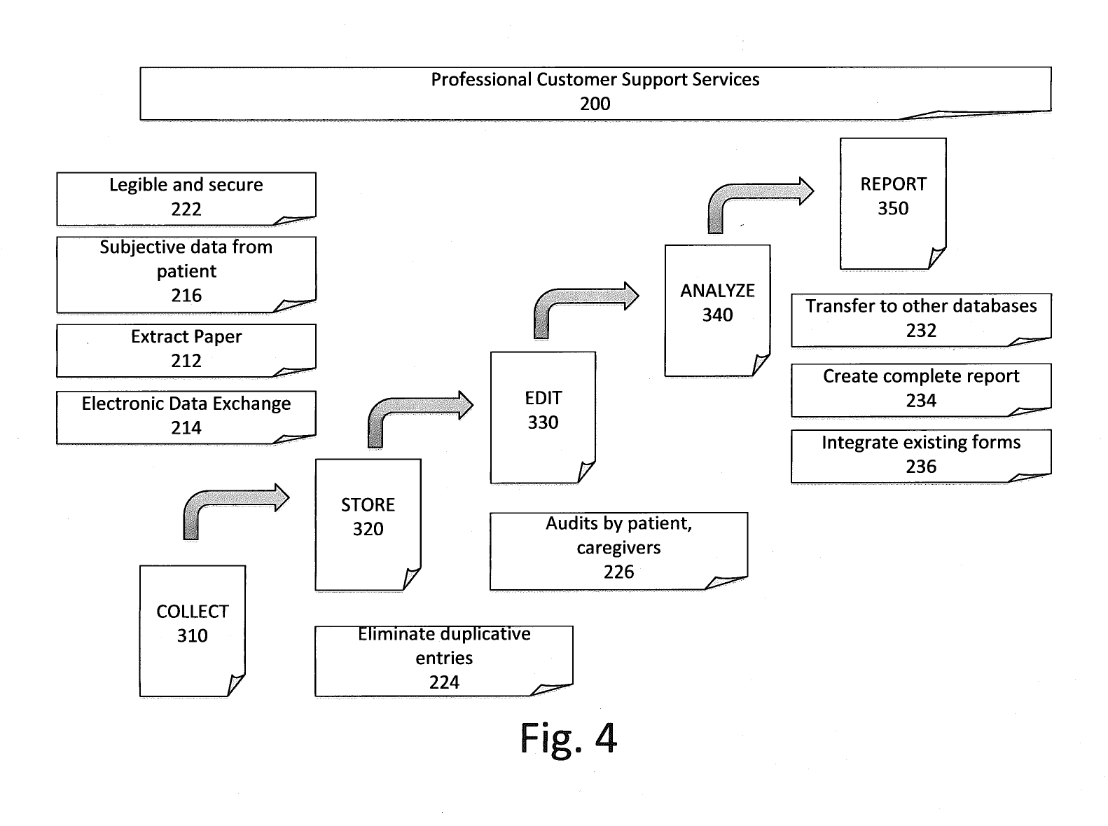

Referring now to FIG. 4, the relationship or alignment between the process 300 of FIG. 3 and the modules of FIG. 2 is shown. In the collection step 310, whereby information is input by a patient 10, hospital 12 or other medical provider's office 14 into the medical record 126 via a computer connected to a communication network, such as the Internet. During the collection step 310, a patient or caregiver can perform a paper record extraction 212 removing a data set from a paper medical record and incorporating the data into an electronic medical record. The patient 10 or the patient's caregiver can also upload or import existing electronic data during the collection step 310 and the uploaded or imported data is then incorporated into the electronic medical record 126. Additional data is collected during the collection step 310 through subjective data collection from the patient 216, whereby a patient 10 accesses and completes an interactive questionnaire, e.g., on the server 110 accessed through the computer network 130 using the client computer system 120. The data from the questionnaire is then incorporated into the electronic medical record 126. The final step of the collection step 310 is compiling all the data into a legible and secure format 222 to ensure accuracy. The present system may incorporate or be used in conjunction with commercially available patient interviewing or medical history software such as Instant Medical History™ software available from Primetime Medical Software, Inc., of Columbia, S.C. The Instant Medical History™ software uses branching logic to ask patients questions about specific medical conditions, general health, or family history.

Once the data has been collected and formatted it is then stored, e.g., in a file or in a database or data store, on a secure network. In FIG. 5, the electronic medical records 126 are illustrated as being stored in a memory of the service system 110. It will be recognized that the electronic medical records 126 may be stored in the memory of another computer. During the storing process 320, duplicative entries are eliminated 224, thereby making reviewing the electronic medical record more efficient. A patient 10 or caregiver is able to make audits 226 to an electronic medical record through the edit process 330. The ability to edit the electronic medical record allows a patient 10 or the patient's caregiver to correct any errors or insert omitted information making the electronic medical record more reliable. Once an electronic medical record 126 has been edited at step 330, it is analyzed at step 340.

At step 350, a patient 10 or caregiver can easily transfer the electronic medical record to other systems which are responsible for the patient's care using a network using the transfer module 232. The electronic medical record system enables a patient or caregiver to map database fields from the medical record database to the form required for import by the system in use by the recipient and using standards, such as ASTM CCR, Continuity of Care record (“CCR”) format, and the like.

A complete medical report 128 can be generated using the report module 234 during the report process 350 to deliver the patient's medical information in a format useful to a caregiver. In addition, the report process 350 enables a patient 10 or caregiver to integrate the electronic medical data into an existing paper form 236 for easy use by a caregiver. The report process 250 also enables the patient 10 or caregiver to map database fields onto a printed template based on forms currently in use by the recipient of the electronic medical data. The map database fields enable the patient 10 to convert the electronic medical data into a printable form that is compatible with a caregiver's own paper-based information system or identical to the doctor's own format.

Although the invention has been described with a certain degree of particularity, it should be recognized that elements thereof may be altered by persons skilled in the art without departing from the spirit and scope of the invention. One of the embodiments of the invention can be implemented as sets of instructions resident in the main memory of one or more computer systems. Until required by the computer system, the set of instructions may be stored in another computer readable memory such as a hard disk drive or in a removable memory such as an optical disk for utilization in a DVD-ROM or CD-ROM drive, a magnetic media for utilization in a magnetic media drive, a magneto-optical disk for utilization in a magneto-optical drive, or a memory card for utilization in a card slot. Further, the set of instructions can be stored in the memory of another computer and transmitted over a local area network or a wide area network, such as the Internet, when desired by the user. Additionally, the instructions may be transmitted over a network in the form of an applet that is interpreted after transmission to the computer system rather than prior to transmission. One skilled in the art would appreciate that the physical storage of the sets of instructions or applets physically changes the medium upon which it is stored electrically, magnetically, chemically, physically, optically, or holographically, so that the medium carries computer readable information.

Having thus described the preferred embodiments, the invention is now claimed to be:

1. An electronic medical record system for creating and storing of electronic medical records, comprising:
a processor for executing an electronic medical record program;
a memory for electronically storing personal data and medical record data associated with a patient;
said memory further storing a digital representation of one or more original source documents associated with the patient, said digital representation of said one or more original source documents retrievable in human viewable form by an operator; and
one or more input devices for entering and/or editing said personal data, said medical record data, or both.

2. The electronic medical record system of claim 1, wherein said personal data includes, for each patient, any one or more of name, date of birth, phone number, and address.

3. The electronic medical record system of claim 1, wherein said medical record data includes, for each patient, any one or more of family medical history, current medical ailments, current medications, surgical history, previous prescriptions, diagnostic testing data, and diagnostic testing results.

4. The electronic medical record system of claim 1, further comprising one or more of:
a display device for viewing said electronic medical records;
a scanner for scanning one or more documents containing the medical record data;
a graphical user interface for providing guided data entry of the medical record data; and
a voice recognition module for converting spoken words into a digitized representation of the medical record data.

5. The electronic medical record system of claim 1, further comprising:
said memory including a database storing said personal data and said medical record data; and
mapping information for mapping said personal data and said medical record data to an electronic format compatible with another electronic information system.

6. The electronic medical record system of claim 1, further comprising:
a report module for generating reports including said personal data, said medical record data, or both.

7. The electronic medical record system of claim 1, further comprising:
a conversion module for converting said personal data, said medical record data, or both into one or more of:
a caregiver's electronic information system and a standardized electronic medical record format.

8. The electronic medical record system of claim 7, wherein the standard electronic medical record format is an ASTM Continuity of Care Record (CCR) standard.

9. The electronic medical record system of claim 1, further comprising:
a secure encrypted connection for remotely accessing the electronic medical record program.

10. The electronic medical record system of claim 1, further comprising:
a help module providing the patient, caregiver, or both access to a medical record specialist to assist with any one or more of creation, updating, auditing, and creating reports of an electronic medical record on said electronic medical record program.

11. A method for creating an electronic medical record, comprising:
collecting medical record data from a patient, a caregiver, or both;
storing the medical record data in a database and associating the medical record data with the patient; and
storing a digital representation of one or more source documents containing medical record data from the patient and associating said digital representation of one or more source documents with the patient.

12. The method of claim 11, further comprising one or both of:
editing the electronic medical record to correct the medical record data, add new medical record data, or both; and
analyzing the electronic medical record for any one or more of errors, gaps, redundancies, completeness, and accuracy.

13. The method of claim 11, further comprising:
obtaining assistance from a medical record specialist to integrate, filter, abstract, and/or resolve conflicts in said electronic medical record on behalf of the patient.

14. The method of claim 10, further comprising:
outputting said electronic medical record.

15. The method of claim 14, wherein said outputting comprises one or more of:
displaying the medical record data in a human-viewable form;
providing the medical record data in the form of a report;
converting the medical record data to a form compatible with the caregiver's medical record system; and
converting the medical record data to an electronic form compatible with the caregiver's medical record system.

16. The method of claim 10, wherein the database is a relational database, said relational database further including historical medical record data for the patient, current medical record data for the patient, or both.

17. The method of claim 16, wherein the historical medical record data includes any one or more of family medical history data, patient medical history data, surgical history data, and previous prescription data.

18. The method of claim 16, wherein the current medical record data includes any one or more of current medical problem data, current medication data, current prescription data, diagnostic test data, and diagnostic test results.

19. The method of claim 10, further comprising:
auditing the medical record data to eliminate duplicates, identify errors, or both.

20. The method of claim 10, wherein the collecting of the medical record data comprises one or more of:
manually inputting the medical record data by a patient, caregiver, or both;
scanning one or more documents containing medical record data; and
receiving input from the patient, caregiver, or both in response to one or more prompts provided by a graphical user interface of a computer based information handling system.
